(19) United States
(12) Patent Application Publication
(10) Pub. No.: US 2013/0329395 A1
(43) Pub. Date: Dec. 12, 2013

(54) FRAME STRUCTURE AND ASSEMBLING METHOD THEREOF

(71) Applicant: Integrated Digital Technologies, Inc., (US)

(72) Inventors: Yueh-Lun TSAI, Hsinchu City (TW); Naejye HWANG, Hsinchu City (TW); Shen-Tai LIAW, Hsinchu City (TW)

(73) Assignee: Integrated Digital Technologies, Inc., Hsinchu City (TW)

(21) Appl. No.: 13/856,166

(22) Filed: Apr. 3, 2013

Related U.S. Application Data
(60) Provisional application No. 61/621,003, filed on Apr. 6, 2012.

(51) Int. Cl. F21V 15/01; F21V 9/14

(52) U.S. Cl. CPC F21V 15/01; F21V 9/14
USPC 362/19; 156/60

(57) ABSTRACT

A frame structure applicable to a touch device is disclosed. The frame structure includes a housing carrying a backlight unit; a first frame disposed on the backlight unit and having first and second abutting surfaces that are perpendicular to each other; a panel disposed on the first frame; a polarizer attached to the panel; a second frame disposed outside the housing and the first frame and abutting against the second abutting surface of the first frame; and a cover plate attached to the first abutting surface of the first frame and bonded to the second frame through an adhesive layer, thereby reducing the gap between the cover plate and the panel, enhancing the strength of the cover plate, causing a touch experience to be more sensitive and precise, reducing the use of adhesive and increasing the product yield.

### BACKGROUND OF THE INVENTION

1. Field of the Invention

The present invention relates to frame structures and assembling methods thereof, and more particularly, to a frame structure and an assembling method thereof applicable to a touch device.

2. Description of Related Art

Recently, touch devices have become quite popular. Touch panels have been widely applied in portable electronic products such as mobile phones, tablet computers and notebook computers. Such a touch panel serves as not only a traditional output interface, but also an input interface to replace a keyboard, a mouse and a pen tablet all at once. Current touch devices are categorized into out-cell and in-cell types. In an out-cell type touch device, a touch sensing device is attached to a surface of a panel, while in an in-cell type touch device, a touch sensing function is directly built inside an array substrate of a panel so as to eliminate the need to attach an additional touch sensing device to the panel.

In-cell type touch panels can be categorized into optical type, capacitive type, resistive type and so on. An optical type in-cell touch panel detects a touch event by sensing the variation of intensity of light passing through the surface of the touch panel. FIG. 1 is a partial cross-sectional view of a frame structure 1 of a conventional touch device. Referring to FIG. 1, the frame structure 1 has a housing 10, a first frame 11, a second frame 12 and a cover plate 13. The housing 10 carries a backlight unit 14 and has a first engaging portion 101. The first frame 11 has a base portion 111, an extending portion 113 and an abutting portion 112. The extending portion 113 is disposed on the backlight unit 14. The abutting portion 112 has a first abutting surface 1121 and a second abutting surface 1122. A panel 15 is disposed on the extending portion 113, and a polarizer 16 is further disposed on the panel 15. The second frame 12 has a positioning portion 122, a second engaging portion 121 and a carrying portion 123. The positioning portion 122 abuts against the second abutting surface 1122, and the second engaging portion 121 engages with the first engaging portion 101 of the housing 10. The carrying portion 123 of the second frame 12 extends to an inner side of the housing 10 and abuts against the first abutting surface 1121 of the abutting portion 112 of the first frame 11. The cover plate 13 is disposed on and bonded to the carrying portion 123 through an adhesive layer 19. As such, a gap H1 is formed between the cover plate 13 and the polarizer 16.

Therefore, if the gap H1 is too large, the cover plate 13 lacks an effective support from the panel 15 and the polarizer 16 when a force is applied on the cover plate 13 by a user. As such, deformation can easily occur to the cover plate 13, thereby reducing the strength of the cover plate 13 and easily causing delamination of the cover plate 13 from the adhesive layer 19 and the carrying portion 123. To ensure an effective bonding between the cover plate 13 and the carrying portion 123, the area of the carrying portion 123 is increased and more adhesive is applied so as to increase the area of the adhesive layer 19. However, during the process, uneven coating may occur to the adhesive layer 19, thus reducing the product yield. Furthermore, if the gap H1 is too large, refraction of light through the cover plate 13 can cause a deviation between a desired touch sensing area and an actual touch sensing area.

Therefore, there is a need to provide a frame structure and an assembling method thereof so as to overcome the above-described drawbacks.

### SUMMARY OF THE INVENTION

The present invention provides a frame structure applicable to a touch device so as to reduce the gap between a cover plate and a panel, enhance the strength of the cover plate, cause a touch experience to be more sensitive and precise, reduce the use of adhesive and increase the product yield.

The present invention provides a frame structure applicable to a touch device, which comprises a housing carrying a backlight unit and having a first engaging portion; a first frame having a first portion disposed on the backlight unit and a second portion connected to the first portion, wherein the second portion has first and second abutting surfaces that are perpendicular to each other; a panel disposed on the first portion of the first frame; a polarizer attached to the panel; a second frame disposed outside the housing and the first frame, wherein the second frame has a second connecting portion and a carrying portion that are substantially perpendicular to each other, and a second engaging portion formed at an end of the second connection portion and engaged with the first engaging portion of the housing; and a cover plate attached to the first abutting surface of the first frame and bonded to the carrying portion of the second frame through an adhesive layer.

The present invention further provides an assembling method of a frame structure applicable to a touch device. The assembling method comprises the steps of: (a) providing a housing carrying a backlight unit, wherein the housing has a first engaging portion and the backlight unit has a first transparent area and a second transparent area; and providing a first frame having a first abutting surface and a second abutting surface that are perpendicular to each other, wherein a portion of the first frame is disposed corresponding in position to the second transparent area of the backlight unit; (b) disposing a panel on the portion of the first frame on the backlight unit and attaching a polarizer to the panel; and (c) bonding a second frame and a cover plate together and disposing the second frame and the cover plate outside the housing, wherein the second frame has a second connecting portion and a carrying portion that are substantially perpendicular to each other, a second engaging portion formed at an end of the second connection portion, and the cover plate is bonded to the carrying portion of the second frame through an adhesive layer, and wherein the second engaging portion is engaged with the first engaging portion of the housing so as for the cover plate to be attached to the first abutting surface of the first frame.

According to the present invention, the cover plate is directly attached to the first abutting surface of the first frame instead of through the second frame as in the prior art, thus reducing the gap between the cover plate and the panel, enhancing the strength of the cover plate, causing a touch experience to be more sensitive and precise, reducing the use of adhesive and increasing the product yield.

### BRIEF DESCRIPTION OF DRAWINGS

FIG. 1 is a partial cross-sectional view of a conventional frame structure;

FIG. 2A is a partial cross-sectional view of a frame structure of the present invention;

FIG. 3 is schematic view showing a touch sensing result according to the present invention; and

FIG. 4 is a flow diagram showing an assembling method of the frame structure of the present invention.

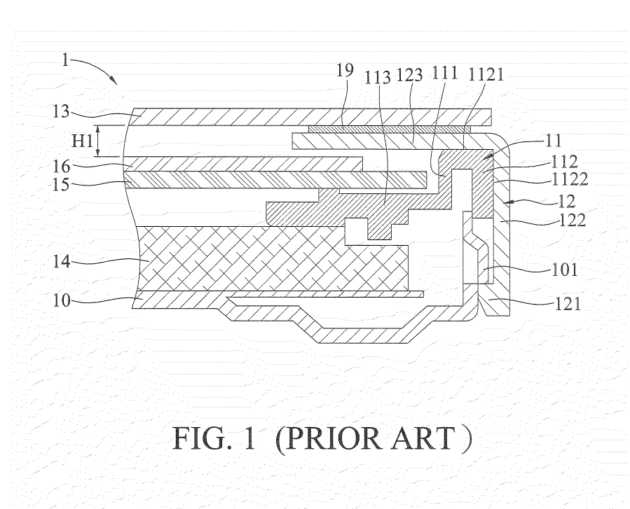

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are only for illustrative purpose and not intended to limit the present invention. Various modification and variations can be made without departing from the spirit of the present invention. Further, terms such as “first”, “a”, etc. are merely for illustrative purpose and should not be construed to limit the scope of the present invention.

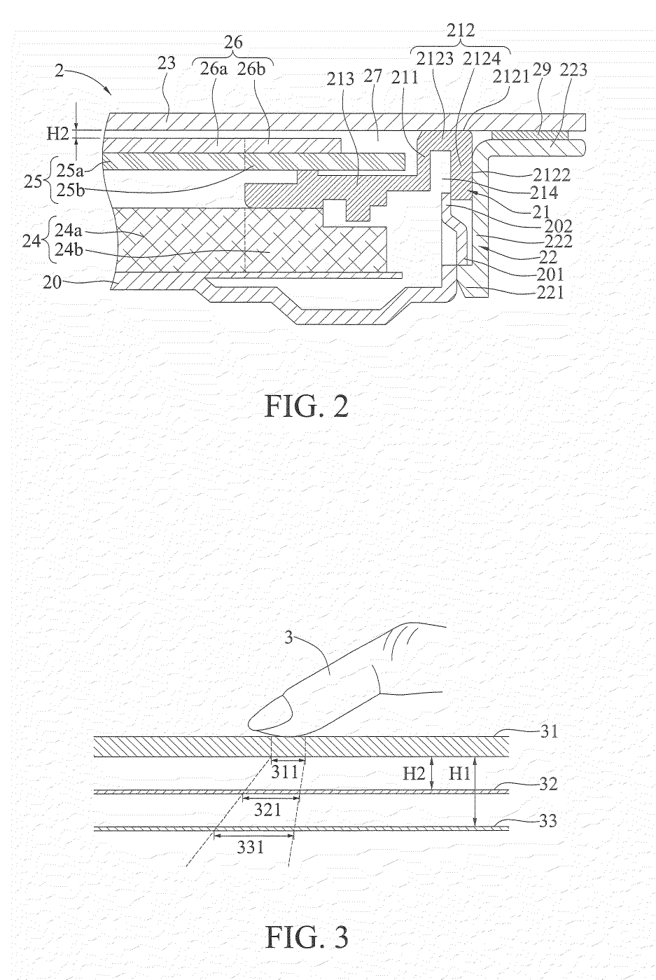

FIG. 2 is a partial cross-sectional view of a frame structure of the present invention.

Referring to FIG. 2, the frame structure 2 is applicable to a touch device. The frame structure 2 has a housing 20, a first frame 21, a panel 25, a polarizer 26, a second frame 22 and a cover plate 23. The housing 20 carries at least a backlight unit 24, and has a first engaging portion 201 and a first connecting portion 202. The first connecting portion 202 is located at an end of the housing 20, and the first engaging portion 201 extends from the first connecting portion 202 and progressively protrudes from the housing 20.

The first frame 21 is partially disposed on the backlight unit 24. The first frame 21 has a base portion 211, and an abutting portion 212 and an extending portion 213 extending from two ends of the base portion 211, respectively. The abutting portion 212 extends from an upper end of the base portion 211 in a direction opposite to the panel 25 so as to form a horizontal portion 2123 and a vertical portion 2124 that are substantially perpendicular to each other. Therefore, the base portion 211 and the abutting portion 212 form a substantially inverted U-shaped structure with a concave portion 214. The horizontal portion 2123 of the abutting portion 212 has a first abutting surface 2121 opposite to the concave portion 214, and the vertical portion 2124 of the abutting portion 212 has a second abutting surface 2122 opposite to the concave portion 214. The first abutting surface 2121 is completely attached to the cover plate 23. The extending portion 213 horizontally extends from a lower end of the base portion 211 and between the backlight unit 24 and the panel 25. In particular, only the extending portion 213 of the first frame 21 is disposed on the backlight unit 24, and the base portion 211 and the abutting portion 212 of the first frame 21 are not disposed on the backlight unit 24. The concave portion 214 of the first frame 21 is disposed corresponding in position to the first connecting portion 202 of the housing 20, such that the first connecting portion 202 partially extends to and engage with the concave portion 214. In the present embodiment, the first frame 21 is made of plastic.

The second frame 22 is disposed outside the housing 20 and the first frame 21. The second frame 22 has a second connecting portion 222 and a carrying portion 223 that are substantially perpendicular to each other. The second connecting portion 222 abuts against the abutting portion 212 of the first frame 21 and at least a portion of the second connecting portion 222 is in contact with the second abutting surface 2122 of the abutting portion 212. In particular, the portion of the second connecting portion 222 in contact with the second abutting surface 2122 is close in position to the junction between the second connecting portion 222 and the carrying portion 223, and a second engaging portion 221 is formed at the opposite end of the second connecting portion 222 for engaging with the housing 20. In the present embodiment, the second engaging portion 221 has a hook-shaped structure protruding from the second connecting portion 222 for engaging with the first engaging portion 201 of the housing 20. After the second connecting portion 222 abuts against the second abutting surface 2122, the second engaging portion 221 engages with the first engaging portion 201 to thereby position the second frame 22. The first connecting portion 202 partially extends to the concave portion 214 such that the vertical portion 2124 of the abutting portion 212 of the first frame 21 is sandwiched between the first connecting portion 202 of the housing 20 and the second connecting portion 222 of the second frame 22, and the second connecting portion 222 is partially in contact with the second abutting surface 2122. In the present embodiment, the second frame 22 is made of metal such as iron. In an embodiment, the carrying portion 223 has an L-shaped structure.

The cover plate 23 is attached to the first abutting surface 2121 of the abutting portion 212 of the first frame 21 and bonded to the carrying portion 223 through an adhesive layer 29. That is, the cover plate 23 is carried by the abutting portion 212 of the first frame 21 and the carrying portion 223 of the second frame 22 so as to be horizontally disposed on the top of the overall frame structure 2, thereby protecting the polarizer 26 and the panel 25 against scratches caused by touch motion. In particular, the carrying portion 223 is completely covered by the adhesive layer 29. The frame structure 2 is closed by bonding the carrying portion 223 and the cover plate 23 together. In the present embodiment, the cover plate 23 is made of glass. Preferably, the cover plate 23 is made of transparent reinforced glass. In an embodiment, the adhesive layer 29 is made of double-sided adhesive tape.

The first frame 21 can be non-transparent. The backlight unit 24 has a first transparent area 24a and a second transparent area 24b, and the extending portion 213 of the first frame 21 is disposed corresponding in position to the second transparent area 24b such that the first transparent area 24a is located outside the first frame 21, and the second transparent area 24b is located under the first frame 21. The extending portion 213 of the first frame 21 is used for carrying the panel 25. Further, the polarizer 26 is attached to a surface of the panel 25. Since the extending portion 213 is disposed on the second transparent area 24b, light emitting from the second transparent area 24b of the backlight unit 24 is blocked by the extending portion 213. As such, portions of the panel 25 and the polarizer 26 located on the extending portion 213 define a light blocking area 25b of the panel 25 and a light blocking area 26b of the polarizer 26, and the other portions of the panel 25 and the polarizer 26 not located on the extending portion 213 define a viewing area 25a of the panel 25 and a viewing area 26a of the polarizer 26. The viewing area corresponds in position to the first light transparent area 24a of the backlight unit 24 and allows a user to see light emitting from the backlight unit 24. The light blocking area corresponds in position to the second transparent area 24b of the backlight unit 24.

In an embodiment, the cover plate 23 is attached to a surface of the polarizer 26. In another embodiment, a gap H2 is formed between the cover plate 23 and the polarizer 26 such that a space 27 is formed between the cover plate 23, the polarizer 26, the panel 25 and the first frame 21. The space 27 can be filled with air, optical clear resin (OCR) or optical clear adhesive (OCA).

According to the present invention, the first abutting surface 2121 of the abutting portion 212 directly abuts against the cover plate 23 instead of through the carrying portion as in the prior art, thereby reducing the gap H2 between the cover plate 23 and the polarizer 26. As such, the cover plate 23 can be disposed much closer to the panel 25 and the polarizer 26. Therefore, when a force is applied on the cover plate 23, since the cover plate 23 is effectively supported by the panel 25 and the polarizer 26, deformation of the cover plate 23 can be alleviated, thereby preventing delamination of the cover plate 23 from the adhesive layer 29 and the second frame 22 as in the prior art. Therefore, the use of adhesive is reduced in the present invention, thereby reducing the fabrication cost and facilitating an even coating process and consequently increasing the product yield.

Further, a small gap H2 causes a touch experience to be more sensitive and precise. Referring to FIG. 3, when a cover plate 31 is pressed by a finger 3, if a panel 32 has a gap H2 with the cover plate 31, a touch sensing area 321 is generated on the panel 32. On the other hand, if a panel 33 has a gap H1 with the cover plate 31 and the gap H1 is greater than the gap H2, a touch sensing area 331 is generated on the panel 33. Owning to refraction of light through the cover plate 31, the touch sensing area 331 is larger than the original finger touch area 311 and the touch sensing area 321 and deviates more from the original finger touch area 311 as compared with the touch sensing area 321. Therefore, compared with the touch sensing area 331, the touch sensing area 321 is closer in position to the finger touch area 311 and leads to a more sensitive and precise touch experience for the user.

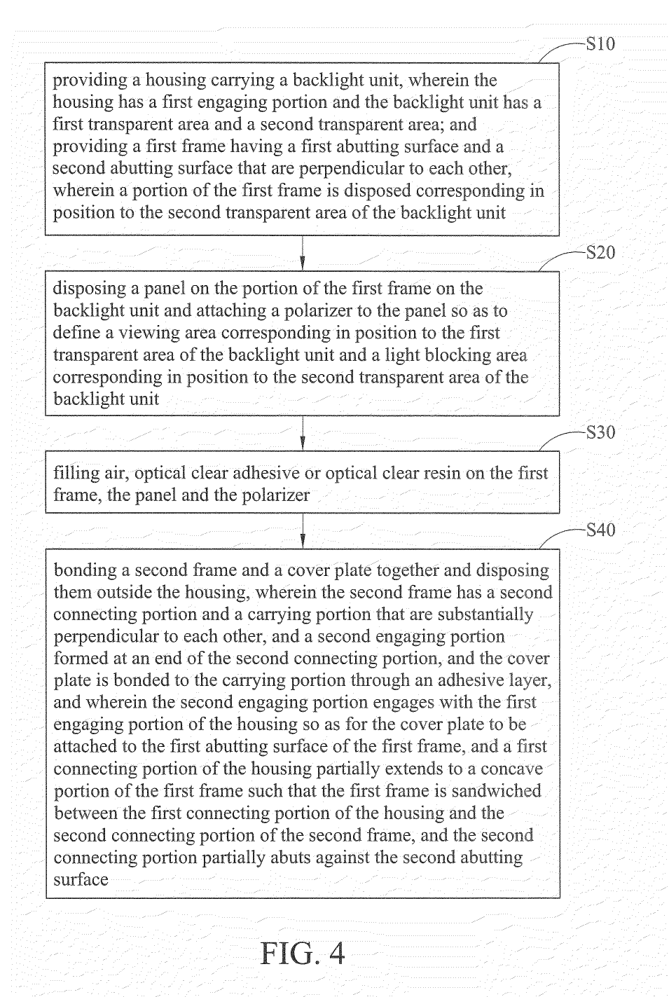

FIG. 4 is a flow diagram showing an assembling method of the frame structure of the present invention. Referring to FIG. 4, in step S10, a housing is provided for carrying a backlight unit. The housing has a first engaging portion and the backlight unit has a first transparent area and a second transparent area. A first frame is provided. The first frame has a first abutting surface and a second abutting surface that are perpendicular to each other. A portion of the first frame is disposed corresponding in position to the second transparent area of the backlight unit. In step S20, a panel is disposed on the portion of the first frame on the backlight unit, and a polarizer is attached to the panel such that a viewing area corresponding in position to the first transparent area of the backlight unit and a light blocking area corresponding in position to the second transparent area of the backlight unit are defined by the panel and the polarizer. In step S40, a second frame and a cover plate are bonded together and disposed outside the housing. The second frame has a second connecting portion and a carrying portion that are substantially perpendicular to each other, and a second engaging portion is formed at an end of the second connecting portion. The cover plate is bonded to the carrying portion through an adhesive layer. The second engaging portion engages with the first engaging portion of the housing so as for the cover plate to be attached to the first abutting surface of the first frame. The first connecting portion of the housing partially extends to a concave portion of the first frame such that the first frame is sandwiched between the first connecting portion of the housing and the second connecting portion of the second frame, and the second connecting portion partially abuts against the second abutting surface. In step S40, the carrying portion is completely covered by the adhesive layer. The adhesive layer can be made of a double-sided adhesive tape. After step S20 and before step S40, step S30 of filling air, optical clear adhesive or optical clear resin on the first frame, the panel and the polarizer can be performed. The viewing area is not filled with the optical clear adhesive or optical clear resin. Through the above-described steps, a frame structure is obtained.

Therefore, compared with a conventional process that sequentially disposes a first frame, a second frame and a cover plate on a housing, the present invention bonds the cover plate and the second frame together through an adhesive layer first and then disposes them on the housing so as to save time and reduce the risk of damage to the panel and hence increase the product yield.

The above-described descriptions of the detailed embodiments are only to illustrate the preferred implementation according to the present invention, and it is not intended to limit the scope of the present invention. Accordingly, all modifications and variations completed by those with ordinary skill in the art should fall within the scope of present invention defined by the appended claims.

What is claimed is:

1. A frame structure applicable to a touch device, comprising:
a housing carrying a backlight unit and having a first engaging portion;
a first frame having a first portion disposed on the backlight unit and a second portion connected the first portion, wherein the second portion has first and second abutting surfaces that are perpendicular to each other;
a panel disposed on the first portion of the first frame;
a polarizer attached to the panel;
a second frame disposed outside the housing and the first frame, wherein the second frame has a second connecting portion and a carrying portion that are substantially perpendicular to each other, and a second engaging portion formed at an end of the second connection portion and engaged with the first engaging portion of the housing; and
a cover plate attached to the first abutting surface of the first frame and bonded to the carrying portion of the second frame through an adhesive layer.

2. The structure of claim 1, wherein the first frame is made of plastic, the second frame is made of metal, and the cover plate is made of glass.

3. The structure of claim 1, wherein the carrying portion of the second frame is completely covered by the adhesive layer.

4. The structure of claim 1, wherein the carrying portion has an L-shaped structure.

5. The structure of claim 1, wherein the first frame further has a concave portion and the housing further has a first connecting portion partially extending to the concave portion, such that the first frame is sandwiched between the first connecting portion of the housing and the second connecting portion of the second frame, and the second connecting portion of the second frame partially abuts against the second abutting surface of the first frame.

6. The structure of claim 1, wherein the first abutting surface of the first frame is completely attached to the cover plate.

7. The structure of claim 1, wherein the backlight unit has a first transparent area and a second transparent area, and the first portion of the first frame is disposed corresponding in position to the second transparent area.

8. The structure of claim 7, wherein a viewing area corresponding in position to the first transparent area of the backlight unit and a light blocking area corresponding in position to the second light transparent area of the backlight unit are defined by the panel and the polarizer.

9. The structure of claim 8, wherein a space is defined by the light blocking area, the first frame and the cover plate, and filled with air, optical clear resin or optical clear adhesive.

10. An assembling method of a frame structure applicable to a touch device, comprising the steps of:
(a) providing a housing carrying a backlight unit, wherein the housing has a first engaging portion, and the backlight unit has a first transparent area and a second transparent area; and providing a first frame having a first abutting surface and a second abutting surface that are perpendicular to each other, wherein a portion of the first frame is disposed corresponding in position to the second transparent area of the backlight unit;
(b) disposing a panel on the portion of the first frame on the backlight unit and attaching a polarizer to the panel; and
(c) bonding a second frame and a cover plate together and disposing the second frame and the cover plate outside the housing, wherein the second frame has a second connecting portion and a carrying portion that are substantially perpendicular to each other, a second engaging portion is formed at an end of the second connection portion, and the cover plate is bonded to the carrying portion of the second frame through an adhesive layer, and wherein the second engaging portion is engaged with the first engaging portion of the housing so as for the cover plate to be attached to the first abutting surface of the first frame.

11. The method of claim 10, wherein in step (c), when the second engaging portion is engaged with the first engaging portion of the housing, a first connecting portion of the housing partially extends to a concave portion of the first frame, such that the first frame is sandwiched between the first connecting portion of the housing and the second connecting portion of the second frame, and the second connecting portion of the second frame partially abuts against the second abutting surface of the first frame.

12. The method of claim 10, wherein the carrying portion of the second frame is completely covered by the adhesive layer.

13. The method of claim 10, wherein in step (b), a viewing area corresponding in position to the first transparent area of the backlight unit and a light blocking area corresponding in position to the second light transparent area of the backlight unit are defined by the panel and the polarizer.

14. The method of claim 10, wherein step (b) further comprises filling air, optical clear resin or optical clear adhesive on the first frame, the panel and the polarizer.
